(19) United States
(12) Patent Application Publication
(10) Pub. No.: US 2018/0212766 A1
(43) Pub. Date: Jul. 26, 2018

(54) ASYMMETRIC CONTENT PROTECTION OF LARGE DATASTREAMS

(71) Applicant: Six Degrees Space Ltd, Jerusalem (IL)

(72) Inventor: Daniel GREENSPAN, Jerusalem (IL)

(21) Appl. No.: 15/878,434

(22) Filed: Jan. 24, 2018

Related U.S. Application Data
(60) Provisional application No. 62/449,631, filed on Jan. 24, 2017.

(51) Int. Cl. H04L 9/08; H04L 9/14; H04L 9/30; G06F 21/10

(52) U.S. Cl. CPC H04L 9/0822; H04L 9/0861; H04L 9/14; G06F 2221/0755; G06F 21/10; H04L 2209/603; G06F 2221/0753; H04L 9/30

(57) ABSTRACT

A content protection system includes an encrypter to encrypt fragments of a datastream, each with one of a multiplicity of related encryption keys, so as to require a decrypter to use limited exhaustive key searches to determine the corresponding decryption keys. The encrypter includes a key generator to generate the encryption keys and an individual key encrypter to encrypt each the fragment with its associated encryption key. Each encryption key is a function of a disclosed key and an additional random parameter.

A content presentation system includes a fragment selector and a key deriver. The fragment selector selects a fragment of a datastream to present to a user based on a user selection. The key deriver finds the value of the additional random parameter to determine the individual key for decrypting the selected fragment.

### CROSS REFERENCE TO RELATED APPLICATIONS

This application claims priority from U,S, provisional patent application 62/449,631, filed Jan. 24, 2017, which is incorporated herein by reference.

### FIELD OF THE INVENTION

The present invention relates to content protection generally and to decryption of a subset of such protected content in particular.

### BACKGROUND OF THE INVENTION

Virtual reality systems, and its related technologies of mixed realty (MR) and augmented reality (AR), can generate image content of many views of a scene, as described in more detail hereinbelow, and then present a user with a subset of the available content, for example, according to where the user's head is facing. For example, in a VR environment, when a user is looking towards their feet, it is not necessary to provide the image content of the view above their heads.

Shown in FIG. 1, to which reference is now made, is an overall VR system, including a VR content creation system 11, a content delivery system, such as broadcast network 17, and a VR content consumption system 15. To create VR content, VR content creation system 11 utilizes a series of cameras 10 viewing a scene from many different angles to provide the raw image data suitable to cover the required viewing positions and orientations.

An exemplary scene is shown in FIG. 2, which is a simplified illustration of a scene depicting three adults (P, Q, R), three large square pieces of equipment (T, U, V), and one child (S). The scene also depicts a number of different viewing locations (a,b,c,d,e,f) from which the scene may be viewed (for example by different users each viewing a live VR stream from a different user-chosen location). From each of the locations, a range of viewing orientations may be chosen (for example by the user rotating their head accordingly) and three such viewing orientations are illustrated for location d. FIGS. 3A, 3B, 3C, 3D, 3E and 3F depict the different views that may be seen from the viewing locations (a,b,c,d,e,f), respectively, depicted in FIG. 2. Thus, FIGS. 3A, 3B, 3C, and 3D show the view from the top, front left, front center, and front right, and FIGS. 3E and 3F are close up and bird's eye views. FIGS. 4A-4C present the different views that may be seen from the viewing orientations (1), (2), and (3) at location d, as close-up views looking left, center and right, respectively. Note that each view contains some detail unique to that view (even if very subtle) and no view can be fully and accurately created from other views. The term “user position” may be used to represent a combination of viewing location and viewing orientation for a particular user at a particular time.

Referring back to FIG. 1, a stitching and voxel creator 12 aggregates and/or stitches together the output of cameras 10, such as might view the scene of FIG. 2, into a large datastream with annotations such that data for a particular viewing position and orientation may be extracted from the data. The large datastream may comprise a succession of such aggregates, each taken during the same time period, such as over an 8.33 ms time period.

Since, for many applications, the overall VR system only wants authorized users to access the datastream, such applications typically also include an encrypter 14 which encrypts the large datastream using the license or key given to it by a DRM (digital rights management) server 16.

The VR content delivery system 11 then provides the datastream to VR content consumption system 15, such as by broadcasting the entire datastream through the internet or other broadcasting network 17. VR content consumption system 15 typically includes a plurality of receivers 18, each connected or implemented in a corresponding headset 20, worn by a user.

Each receiver 18 extracts a specific portion of datastream, typically based on where the user is looking. Each receiver 18 typically includes a DRM client 19, which is in contact with DRM server 16, and the extraction process typically involves decrypting the specific portion using the license or key authorized by and received from DRM server 16. In such systems, the disclosed encryption key applies to the entire datastream irrespective of where the user may be looking.

Decrypting the specific portion may involve decrypting the entire datastream or it may involve decrypting only those portions that need to be provided to the user. For example, Foveated Imaging (or Foveated Rendering) takes advantage of the limitations of the human eye to only deliver to the user the specific portion of the datastream at which the user is believed by the system to be directly looking at and then to provide the highest-resolution image at this portion of the screen. Other areas of the screen may be provided with lower-resolution images, allowing the system to save graphics computation effort, memory bandwidth, link bandwidth, or some combination of these. This provides benefits in terms of overall system power, and in scenarios such as un-tethered VR, may allow high graphics resolutions to be sent over wireless links that can normally only carry lower resolutions. In some situations, the low-resolution details of the scene may be sent unencrypted, to allow even unauthorized users to access the low-resolution details of the scene, encouraging a large viewing audience in the expectation that a significant proportion of this audience would be willing to pay to upgrade to receive high-resolution details of the portion of the scene they are directly looking at.

For foveated imaging to work, headset 20 includes sensors to provide information to receiver 18 about where the user is looking. Receiver 18 then extracts the relevant part of the image and provides it at high resolution to headset 20 for display.

One further industry technique relates to the capture, storage, manipulation and display of images such that the image is preserved as a “lightfield”, whereby the actual control of the formation of a 2D image on the user's retina is controlled by the user's real-time choice of focal point and depth of field, as controlled by the dynamically changing magnification power and iris of the human eye's lens. A suitable headset may measure various parameters of the human eye to determine where it is looking or is focused, and provides a suitably defocused, 2D image that would form a similar image on the user's retina as would a true lightfield.

### SUMMARY OF THE PRESENT INVENTION

It is therefore provided, in accordance with a preferred embodiment of the present invention, a content protection system including an encrypter to encrypt fragments of a datastream, each with one of a multiplicity of related encryption keys, so as to require a decrypter to use limited exhaustive key searches to determine the corresponding decryption keys.

Moreover, in accordance with a preferred embodiment of the present invention, the encrypter includes a key generator to generate the encryption keys and an individual key encrypter to encrypt each the fragment with its associated encryption key. Each encryption key is a function of a disclosed key and an additional random parameter.

Further, in accordance with a preferred embodiment of the present invention, the encrypter includes a distributor to encrypt the disclosed key via a DRM (digital rights management) server and to distribute the encrypted fragments and the encrypted disclosed key to recipients.

Still further, in accordance with a preferred embodiment of the present invention, an entropy or a size of the random parameter limits a rate at which the decrypter derives correct encryption keys.

Additionally, in accordance with a preferred embodiment of the present invention, the key generator includes a random value generator to generate a multiplicity of additional random parameters and a key mixer to mix the disclosed key with each the additional random parameter.

Further, in accordance with a preferred embodiment of the present invention, the system includes a validity coder to add an associated validation code to each of the fragments.

Alternatively, in accordance with a preferred embodiment of the present invention, the system includes a scrambler, operative on the fragments prior to encryption by the individual key encrypter.

Further, in accordance with a preferred embodiment of the present invention, only a user-selectable portion of the datastream is to be provided to the user and access to an entirety of the datastream is to be prevented.

Still further, in accordance with a preferred embodiment of the present invention, the content may be virtual reality content, foveated content, a digital library, an online, map, a localized weather forecast, and a database of stock prices.

Moreover, in accordance with a preferred embodiment of the present invention, the fragment is a small packet associated with a larger portion of the datastream.

Alternatively, in accordance with a preferred embodiment of the present invention, wherein the disclosed key is a seed used in forming pairs of public and private keys. In this embodiment, each encryption key is a public key generated from said the key and the additional random parameter. The distributor distributes an encrypted version of the seed.

There is also provided, in accordance with a preferred embodiment of the present invention, a content presentation system including a fragment selector and a key deriver. The fragment selector selects a fragment of a datastream to present to a user based on a user selection. The key deriver derives an individual decryption key for the selected fragment, where the individual key is formed from a received disclosed key for the datastream and an additional random parameter. The key deriver finds the value of the additional random parameter and uses the individual key to decrypt the selected fragment.

Moreover, in accordance with a preferred embodiment of the present invention, 13. The system according to claim 12 wherein the user-selection is an area which the user is looking directly at, user location and viewing angle, the tilt of the user's head, spectral content or shape, costume, weapon or location of main characters of a film, a single item of a library, the user's location, or the user's currently selected stock.

Further, in accordance with a preferred embodiment of the present invention, the key deriver includes a limited exhaustive key searcher to search for permutations of the additional random parameter.

Still further, in accordance with a preferred embodiment of the present invention, the key deriver includes a systematic value generator, a key mixer, a decrypter and a valid fragment detector. The systematic value generator generates a random parameter. The key mixer mixes the disclosed key with the random parameter to generate a candidate key. The decrypter attempts to decrypt an incoming fragment with the candidate key and the valid fragment detector determines if the output of the decrypter is valid and instructs the systematic value generator to generate another random parameter if not.

Additionally, in accordance with a preferred embodiment of the present invention, the system includes a descrambler to descramble the fragments.

Further, in accordance with a preferred embodiment of the present invention, the valid fragment detector includes one of a data format checker to check that the fragment contains valid data patterns according to a known fragment format, a data value checker to check that the fragment data values are valid according to a known fragment data scheme, a CRC checker to check the cyclic redundancy check (CRC) of the fragment and a header checker to check header information for expected values of header information.

Still further, in accordance with a preferred embodiment of the present invention, a rate at which the key deriver generates the valid fragment defines the size of the random parameter. For example, the rate is one of: less than a time interval for displaying the fragment or an image associated with the fragment, to the user, and less than half a time interval for displaying the fragment or an image associated with the fragment, to the user allowing time for two fragments to be decoded for provision to both user eyes, less than quarter a time interval for displaying two the fragments or images associated with the fragments, to the user, leaving time for the key deriver to derive two additional valid fragments for a second user.

Moreover, in accordance with a preferred embodiment of the present invention, the system also includes a DRM client to decrypt the disclosed key from a transmitted encrypted version.

Further, in accordance with a preferred embodiment of the present invention, the disclosed key is a seed used in forming pairs of public and private keys. In this embodiment, the DRM client decrypts an encrypted version of the seed and the decryption system generates the private key from the seed and the additional random parameter.

There is also provided, in accordance with a preferred embodiment of the present invention, a content protection method including encrypting fragments of a datastream, each with one of a multiplicity of related encryption keys, so as to require limited exhaustive key searching to determine the corresponding decryption keys.

Moreover, in accordance with a preferred embodiment of the present invention, the encrypting includes generating the encryption keys, wherein each encryption key is a function of a disclosed key and an additional random parameter, and encrypting each the fragment with its associated encryption key.

Further, in accordance with a preferred embodiment of the present invention the method includes encrypting the disclosed key via a DRM server and distributing the encrypted fragments and the encrypted disclosed key to recipients.

Still further, in accordance with a preferred embodiment of the present invention, an entropy or a size of the random parameter limits a rate at which the searching derives correct encryption keys.

Moreover, in accordance with a preferred embodiment of the present invention, the generating includes, generating a multiplicity of additional random parameters, and mixing the disclosed key with each the additional random parameter.

Further, in accordance with a preferred embodiment of the present invention, the method includes adding an associated validation code to each of the fragments and/or scrambling the fragments prior to the encrypting.

There is also provided, in accordance with a preferred embodiment of the present invention, a content presentation method including selecting a fragment of a datastream to present to a user based on a user selection, deriving an individual decryption key for the selected fragment, where the individual key is formed from a received disclosed key for the datastream and an additional random parameter, the deriving including finding the value of said additional random parameter; and using the individual key to decrypt the selected fragment.

Further, in accordance with a preferred embodiment of the present invention, the deriving includes performing limited exhaustive searches for permutations of the additional random parameter.

Still further, in accordance with a preferred embodiment of the present invention, the deriving includes systematically generating a random parameter, mixing the disclosed key with the random parameter to generate a candidate key, attempting to decrypt an incoming fragment with the candidate key, and determining if the output of the attempting is valid and repeating the systematically generating, mixing and attempting if not.

Moreover, in accordance with a preferred embodiment of the present invention, the method includes descrambling the fragments.

Further, in accordance with a preferred embodiment of the present invention, the determining includes at least one of: a checking that the fragment contains valid data patterns according to a known fragment format, checking that the fragment data values are valid according to a known fragment data scheme, checking the cyclic redundancy check (CRC) of the fragment and checking header information for expected values of header information.

Still further, in accordance with a preferred embodiment of the present invention, a rate at which the deriving generates the valid fragment defines the size of the random parameter.

Finally, in accordance with a preferred embodiment of the present invention, the method includes decrypting the disclosed key from a transmitted encrypted version.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of an overall virtual reality system of the prior art;

FIG. 2 is a simplified drawing of a scene, useful in understanding the operation of FIG. 1;

FIGS. 3A, 3B, 3C, 3D, 3E and 3F are depictions of the different views that may be seen from the viewing locations (a,b,c,d,e,f) depicted in FIG. 2;

FIGS. 4A, 4B and 4C are depictions of the close-up views looking left, center and right, respectively, that may be seen from the viewing orientations (1), (2), and (3) at location d;

FIG. 5 is a schematic illustration of an improved VR system, constructed and operative in accordance with a preferred embodiment of the present invention;

FIG. 6A is a schematic illustration of a fragment encryption system forming part of the system of FIG. 5;

FIG. 6B is a schematic illustration of a large datastream which is input to the fragment encryption system of FIG. 6A;

FIG. 7 is a schematic illustration of a version of a standard mechanical key, helpful in understanding the operation of the system of FIG. 5;

FIG. 8 is a schematic illustration of a key-deriving decryption system forming part of the system of FIG. 5;

FIGS. 9A, 9B and 9C are timing diagram illustrations of alternative pipelined processes performed by the decryption system of FIG. 8;

FIGS. 10A and 10B are flowchart illustrations of an alternative process to be performed by the systems of FIGS. 5 and 8, respectively; and

FIGS. 11A and 11B are schematic illustrations of an alternative embodiment of the encryption and decryption systems of FIGS. 5 and 8, respectively, using public-private key encryption.

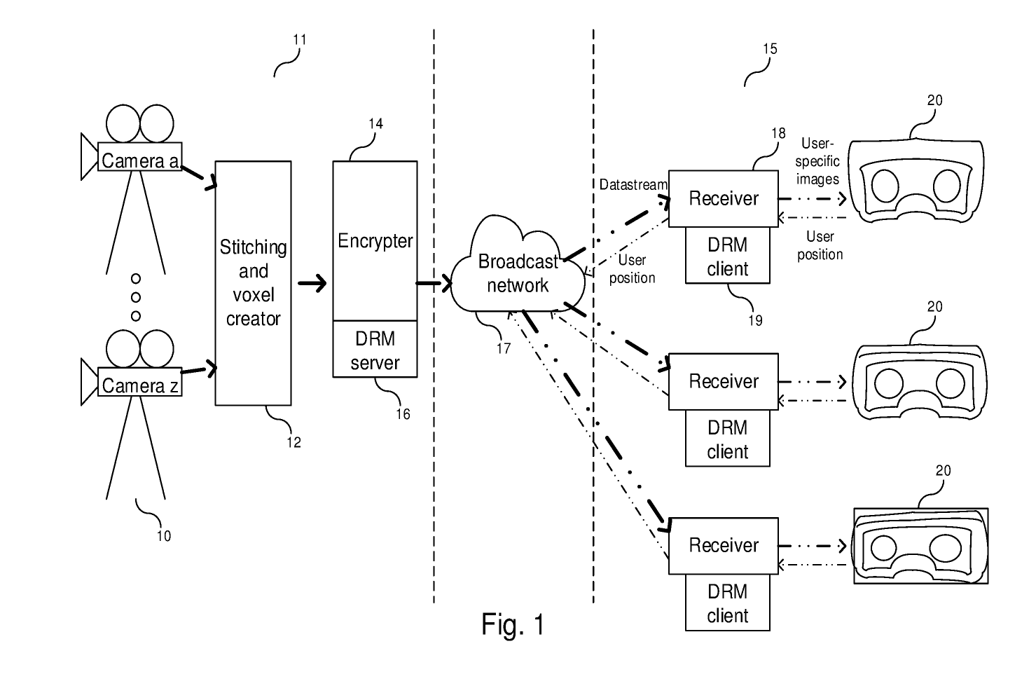

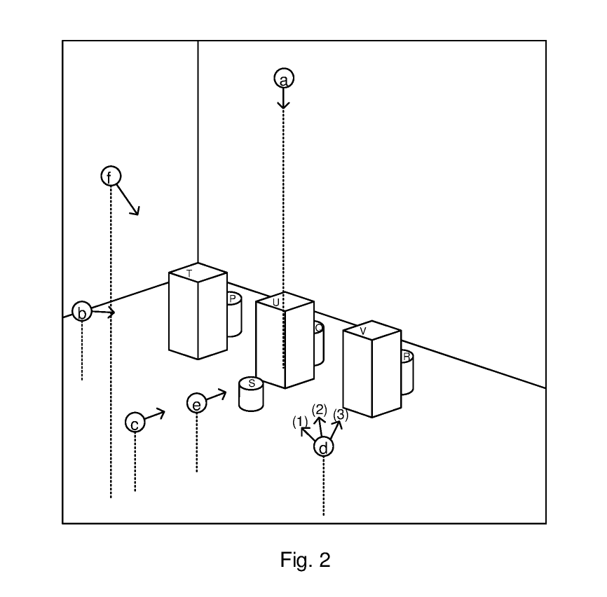

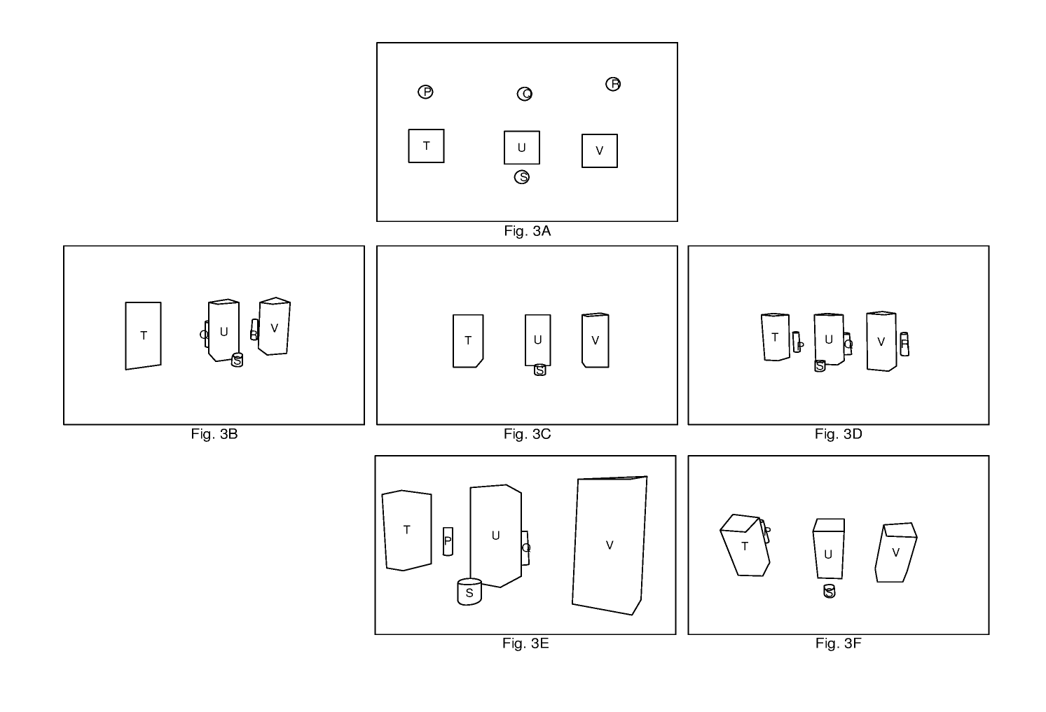

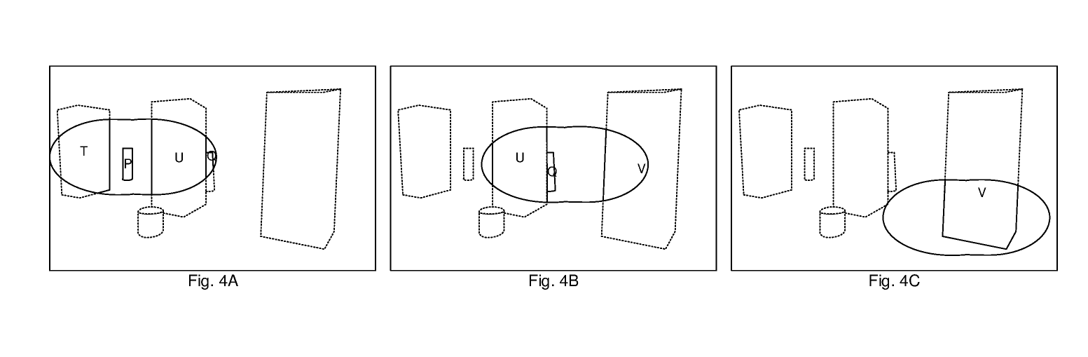

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that a fundamental weakness of common content protection schemes, whether the content is distributed by DVD, internet, etc. or whether it is for immediate or later viewing, is that any approved receiver or playback device must ultimately be provided with the means of decrypting the content. As such, if a hacker found a way to extract the decryption key from an approved receiver device or from some other source, the content may be freely decrypted.

Applicant has realized that systems such as virtual reality, foveated rendering, and lightfield display consume content according to some behavior of a user, such as the direction in which his/her eyes are pointing, and that this may be utilized to improve the content protection in a number of ways. First of all, there is no value in giving one user access to the content that relates to the head position of another user. Secondly, since the user only consumes a subset of the datastream, there is less data to decrypt at any one time and thus, the rate at which the content may be decrypted may be limited to match the rate at which any subset can be consumed.

Applicant has realized that a content protection scheme utilizing these facts may be constructed to require a moderate computational effort to encrypt the full content, and to decrypt any stream of content consumed by a single user. However, the computational effort required to create an unencrypted version of the full content (including all possible views) could be made prohibitive, to the point of being uneconomic for commercial hackers.

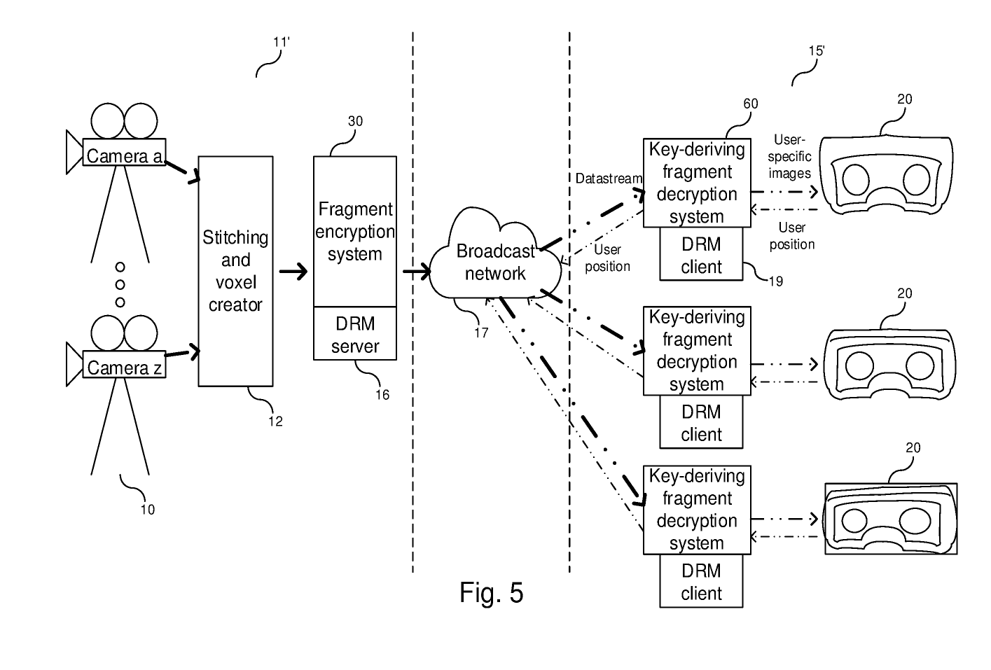

Reference is now made to FIG. 5, which illustrates an improved VR system, including an improved VR content creation system 11′, a content delivery system, such as broadcast network 17, and an improved VR content consumption system 15′.

Improved VR content creation system 11′ may comprise cameras 10, stitching and voxel creator 12 and a novel fragment encryption system 30, typically operating in conjunction with DRM (digital rights management) server 16. As described in more detail hereinbelow, fragment encryption system 30 may individually encrypt each fragment of the large datastream produced by creator 12 with a moderate computational effort.

Fragment encryption system 30 may then provide the encrypted datastream to improved VR content consumption system 15′, such as by broadcasting the entire datastream through the internet or other broadcasting network 17. Improved VR content consumption system 15′ may comprise a plurality of key-deriving, fragment decryption systems 60, each connected to or implemented in a corresponding user headset 20, and each operating with its associated DRM client 19. As described in more detail hereinbelow, fragment encryption system 30 may encrypt individual fragments of the datastream with individual keys. Each key-deriving decryption system 60 may extract a specific portion of the datastream, typically based on where the user is looking, and may determine the relevant individual key using a limited exhaustive key search and may decrypt the extracted portion using that key. In this system, the computing effort for encryption is moderate and the computing effort of each key-deriving decryption system 60 is set according to the expected time required to decrypt and then display a fragment. However, the expected computing effort to decrypt the entire datastream would require an unreasonably large computing effort to unlock the entire content material corresponding to all possible viewpoints over time.

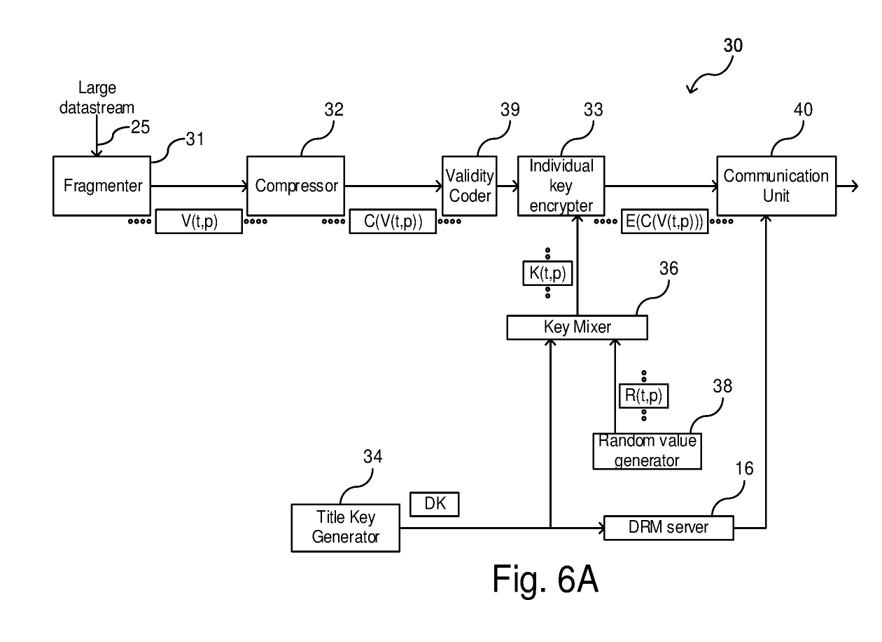

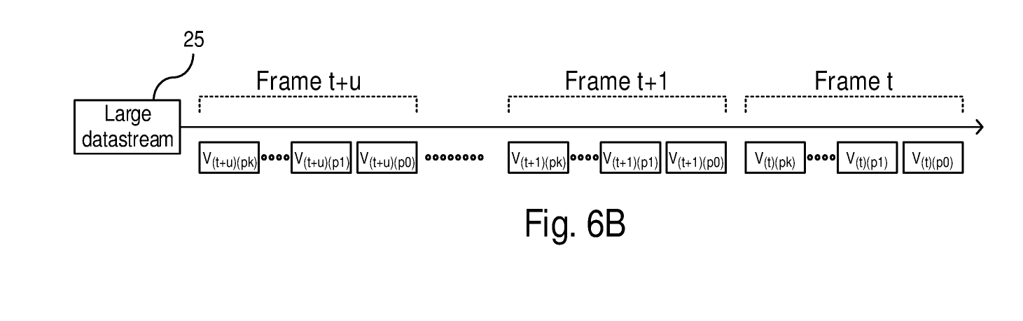

Reference is now made to FIG. 6A, which illustrates fragment encryption system 30, constructed and operative in accordance with a preferred embodiment of the present invention, and to FIG. 6B which illustrates a large datastream 25 which is input to fragment encryption system 30.

Fragment encryption system 30 may encrypt large datastream 25 and may comprise a fragmenter 31, a compressor 32, a validity coder 39, an individual key encrypter 33, a title key generator 34, a key mixer 36, a random value generator 38 and a communication unit 40 and may operate with DRM server 16.

As shown in FIG. 6B, large datastream 25 may be a stream containing data (e.g. video data) pertaining to all viewing positions p, where p=p0, p1 . . . pK, at all times t from t=0 to t=tend. FIG. 6B shows three frames, each having K fragments, one for each viewing position p, for times t, t+1 and t+u.

Returning to FIG. 6A, fragmenter 31 may divide datastream 25 into fragments V(t,p), which may be packets, frames, groups of frames or other section of the data, and may transmit fragments V(t,p) to compressor 32. Typically, fragmenter 31 may transmit fragments V(t,p) related to all positions p (e.g. p0, p1 . . . pK) at time t before transmitting the fragments for all positions p at time t+1, etc.

Compressor 32 may compress each fragment V(t,p), generating an associated compressed fragment C(V(t,p)). The compression technique may be any suitable compression technique, as is known in the art.

Validity coder 39 may add any additional validity bits to encrypted fragment E(C(V(t,p))) which may enable a decrypter to determine that the decryption has been successful. For example, the additional bits may be a predefined header, a set of error correction codes, parity bits, a hash value or any other suitable value. Alternatively, the data stream created by fragmenter 31 and compressor 32 may contain predictable data elements, such as headers or a checksum, such that there is no need for additional information to be added by a validity coder. Alternatively, and depending on the type of data to be encrypted, fragmenter 31, validity coder 39 and compressor 32 may exist external to fragment encryption system 30 or may not be present at all.

In accordance with a preferred embodiment of the present invention, fragment encryption system 30 may provide an individual encryption key for each input fragment, such as compressed fragment C(V(t,p)). In accordance with a preferred embodiment of the present invention, each individual encryption key may be a function of a known (or disclosed) encryption key DK for datastream 25 and a fragment-specific additional random parameter R(t,p).

Title key generator 34 may generate disclosed key DK, when a new title, or datastream 25, is to be encrypted. Title generator 34 may generate disclosed key DK according to any suitable key generation algorithm, as is known in the prior art. DRM server 16 may encrypt disclosed key DK generally at the start of the operation with large datastream 25 and may provide it to communication unit 40 for transmission. Communication unit 40 may provide a path for DRM server 16 to securely deliver disclosed key DK to DRM clients 19.

Random value generator 38 may produce a set of additional random parameters R(t,p), typically one parameter for each fragment C(V(t,p)) to be encrypted. Random parameters R(t,p) may be any suitable random parameter. For example, each random parameter R(t,p) may be a set of X random bits.

Key mixer 36 may mix a fragment-specific additional random parameter R(t,p) with disclosed key DK to generate a per-fragment key K(t,p). Key mixer 36 may utilize any appropriate mixing process, such as concatenation, addition, XOR, manipulation, etc., to mix disclosed key DK with each of the random parameters R(t,p). For example, where random parameters R(t,p) consist of a set of X bits, key mixer 36 may concatenate the bits of disclosed key DK with the bits of each random parameter R(t,p) to form a per-fragment key K(t,p) that is X bits longer than DK. Alternatively, key mixer 36 may XOR the bits of random parameter R(t,p) with the lower X bits of disclosed key DK to form a per-fragment key K(t,p) of the same length as DK. Note that where the mixing is done with concatenation, key K(t,p) has more entropy than disclosed key DK.

In accordance with a preferred embodiment of the present invention, the number X of random bits may be chosen to control a speed at which each key-deriving decryption system 60 may decrypt and display any chosen fragment V(t,p), as described in more detail hereinbelow.

Individual key encrypter 33 may encrypt each compressed fragment C(V(t,p)) using an associated per-fragment key K(t,p), thereby producing individually encrypted compressed fragments E(C(V(t,p))).

Communication unit 40 may then transmit individually encrypted compressed fragments E(C(V(t,p))), along with data indicating time t and position of each fragment, to key-deriving decryption systems 60, by broadcasting the entire encrypted datastream to all systems 60 or by broadcasting a relevant subset of the fragments of the datastream to each headset. The relevant subset may include all data required for anticipated potential locations for the relevant headset 20 connected to key-deriving decryption system 60 at the time at which datastream 25 will be viewed by that headset.

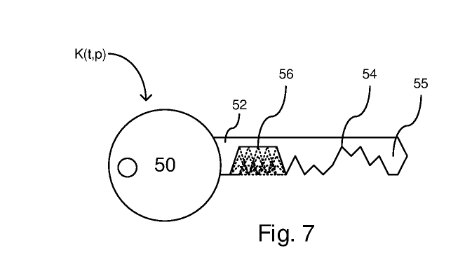

Reference is now made to FIG. 7, which is a schematic illustration of one per-fragment key K(t,p) illustrated using a standard mechanical key, such as may be used to open a mechanical cylindrical lock. FIG. 7 may provide a helpful analogy for the decryption process required to decrypt the individually encrypted compressed fragments E(C(V(t,p))).

Standard mechanical keys have a bow 50, a shank 52 and a series of cuts. In FIG. 7, there are disclosed cuts 54 and undisclosed cuts 56. For keys of this type, the cuts of the key must each be of a depth corresponding to the pin pairs in the cylinder part of the lock. The cylinder may be manufactured with knowledge of both disclosed cuts 54 and undisclosed cuts 56 (i.e. analogous to encrypting with an individual key having a disclosed key and a random parameter).

In order for a user to open the lock, he requires a key whose cuts correspond to the pin pairs in the cylinder part of the lock. The user may go to a ‘key-maker’ to make the key for him. However, in this case, only disclosed cuts 54 may have been disclosed to the key-maker, allowing the key-maker to easily cut a section 55. These disclosed cuts 54 may be considered analogous to the title key or disclosed key DK. The user and thus key-maker may have been provided with no details of undisclosed cuts 56. This has rendered the task of opening the cylinder difficult, as in order to open the cylinder, the key-maker may need to make and the user to try keys with each of the possible combinations of undisclosed cuts 56 until reaching their correct arrangement. This may be quite laborious; however, it is considerably easier than that of a key-maker making and a user trying keys where none of the cuts are known.

Thus, the key derivation process of the present invention may be search for potentially all permutations of random parameter R(t,p) (analogous to undisclosed cuts 56). This may be a “limited exhaustive key search” which may potentially require finding all permutations but on average may be able to stop searching about half-way through the possibilities.

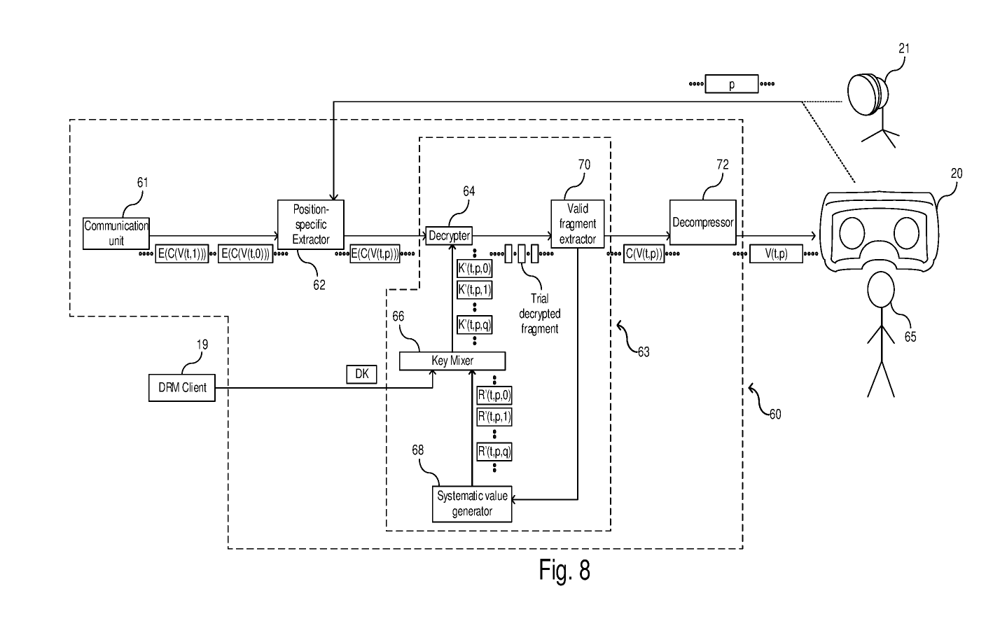

Reference is now made to FIG. 8, which details the elements of key-deriving decryption system 60 which may decrypt (i.e. unlock) content in respect of one user's chosen viewpoints over time, to deliver the content to the user with moderate computational effort. Key-deriving decryption system 60 may comprise a communication unit 61, a position-specific extractor 62, a key deriver 63 and a decompressor 72. Key deriver 63 may comprise a decrypter 64, a key mixer 66, a systematic value generator 68 and a valid fragment extractor 70. Key deriver 63 may derive the individual keys using a limited exhaustive key search by working through permutations of each random parameter.

Communication unit 61 may receive a broadcast stream of encrypted compressed fragments E(C(V(t,p))) and may provide them to position specific extractor 62. Position-specific extractor 62 may receive a position p of a user 65, from headset 20 or from an external tracking unit 21, at time t and may extract the portion E(C(V(t,p))) of the stream relating to the user's position p. The rest of the stream may be discarded as it is not relevant to user 65. In some embodiments, communication unit 61 may request transmission of a subset of the data in the general vicinity of user position p to reduce the amount of data that would be needlessly sent to the communication unit 61 only to be discarded.

Systematic value generator 68 may generate a controlled series of trial keys R′(t,p,q), where q is the trial number, guessing at what the random parameter R(t,p) might have been for that fragment. Key mixer 66 may receive disclosed key DK, decrypted by DRM client 19 and may combine each trial key R′(t,p,q) with disclosed key DK in a similar manner to key mixer 36, to generate a trial key K(t,p,q). Systematic value generator 68 may chose trial keys R′(t,p,q) sequentially or according to any other suitable technique, such as the Pseudo-Random-Binary-Sequence, described in U.S. Pat. No. 4,213,101 to Policand, incorporated herein by reference.

Decrypter 64 may perform the decryption process on portion E(C(V(t,p))) using the current trial key R′(t,p,q) and valid fragment extractor 70 may check the validity indication associated with portion E(C(V(t,p))) to determine if the trial decrypted fragment is garbage (i.e. not a valid fragment). If so, valid fragment extractor 70 may then instruct systematic value generator 68 to proceed to the next trial. However, when systematic value generator 68 may eventually generate the same value that was used by encryption system 30 for fragment E(C(V(t,p))), decrypter 64 may produce a valid fragment. Valid fragment extractor 70 may pass the valid fragment to decompressor 72 for decompression and may indicate the success to systematic value generator 68, which, in turn, may allow systematic value generator 68 to reset itself to prepare for the next fragment to be decrypted.

Valid fragment extractor 70 may, for example, perform a cyclic redundancy check (CRC) of the data and/or may check header information for expected values of a fragment time-stamp and similar metadata. Alternatively, valid fragment extractor 70 may check the fragment contains valid data patterns according to a known fragment format, or that the fragment data values are valid according to a known fragment data scheme.

It will be appreciated that the process performed by key-deriving decryption systems 60 may be a trial-and-error process to find the individual decryption key. However, since random parameter R(t,p) may have a limited range of values (such as those governed by the random parameter being chosen to have only X bits), the time required to perform the entire trial and error process is limited and can be set to match the operational speed of headset 20. As a simplified example, if X is 5, then systematic value generator 68 has to generate at most 2⁵ trials. If, in this simplified example, each trial takes 10 usec, then working through 2⁵=32 trials takes at most 32*10 μsec, approximately one third of a millisecond. Many of the trials are likely to take less than that.

In another example, a speed-optimized hardware implementation of the Data Encryption Standard (DES) algorithm, implemented with FPGA hardware, may have a data throughput of 100 Mbytes/s with a moderate 25 MHz clock. If the frame rate of the video stream to be decrypted is 120 frames per second (FPS), then the rate at which data may be decrypted may be around 830 Kbytes/frame (e.g. dividing the data rate (100 Mbytes/s) by the frame rate (120 frames/s)). This may be reduced if only a portion of a frame is decrypted at a time and may likewise be reduced with more expensive hardware.

In another embodiment, large datastream 25 may be divided into large chunks of data, such as an image for any particular viewing position, and each chunk may have a 128-byte packet associated with it. This packet may carry important information relating to the presentation of the image for that position, or may itself be a key with which to unlock a larger piece of data relating to the presentation of the image for that position. In this embodiment, each 128-byte packet may be V(t,p) and may be individually encrypted as E(C(V(t,p))). Thus, after decrypting E(C(V(t,p))), decryption unit 60 may utilize V(t,p) to unlock the associated larger chunk of data.

For this later embodiment, some 6484 such 128-byte fragments decryption trials may be performed per frame, assuming a decryption rate of 830 Kbytes/frame. Although decryption system 60 may be implemented with similar, low-cost technologies, decryption system 60 is not provided with the entire decryption key. The non-disclosed details might be, for example, a 12-bit random value that was mixed with disclosed key DK. Decryption system 60 has to try up to 2¹² different trial keys formed by mixing disclosed key DK with up to 2¹² different values from systematic value generator 68. Trying keys until successfully decrypting the fragment may require up to (128×2¹²/100,000,000) seconds or 5.24 ms, which, for a frame rate of 120 Hz (i.e. frames arriving at 8.33 ms intervals) allows the full key for any single fragment to be found fast enough for one such key to be found each frame, but would not consistently allow finding the full keys for two or more different fragments (each requiring up to 2¹² trials and therefore a total of up to 10.48 ms, longer than the interval between frames) in real time. It will be clear that generally two video frames are required to be extracted in real time, one for each user eye in the headset, and therefore the choice of an 11-bit random value would allow real-time finding the keys for two fragments to serve a single user, but not the real-time finding of keys for four fragments as would be required to serve two users. It will further be clear that two one-eyed users may be able to each have fragments pertaining to a single eye decrypted in real-time by this system, which may also be considered reasonable giving that each is only consuming half a share of the material that has been licensed.

Use of multiple decryption hardware to speed up the rate at which keys are tried, whether by use of a bank of receivers or by the use of a dedicated cryptographic accelerator, may allow correct trial keys to be discovered in real time for a greater number of user positions.

Encryption system 30 similarly has a moderate load. There may be 10,000 positions available for a user to choose from (i.e. 10,000 fragments per frame), and each of these will need to have its 128-byte per-frame fragment encrypted with a different key. However, unlike decryption system 60, encryption system 30 has full knowledge of each key (as the random parameters are known to it), and therefore there is only one encryption process required for each of the 10,000-per-frame fragments. In total, 10,000 encryptions would be required per frame, i.e. 1,200,000 encryptions per second for a stream of frames at 120 Hz. For 128-byte packets, this would equal 153.6 Mbytes/second of encryption, which only requires encryption hardware to be about 55% more powerful than that of decryption system 60.

In summary; real-time decryption of fragments relating to the position of a single user by use of trial keys is possible using low-cost decryption technology. Similarly, real-time encryption of all fragments relating to all possible user positions is possible using similar low-cost encryption technology. However, real-time decryption of all fragments relating to the positions of a number of users is only possible using technology whose cost scales approximately linearly with the number of positions to be decrypted (which itself scales approximately linearly with the number of users, except in the case of a very large number of users).

It will be appreciated that the present invention limits the amount of data that can be decrypted in real time by decryption system 60 to little more than the amount of data that can be consumed by a single user in real-time. This is provided by placing a hardware complexity bottleneck on the rate at which the decryption keys may be derived by the receiver (i.e. decryption system 60). A fragmentation scheme, and the non-sharing of encryption keys between the fragments relating to different positions and times, ensures that keys derived for one user are of little use to another user.

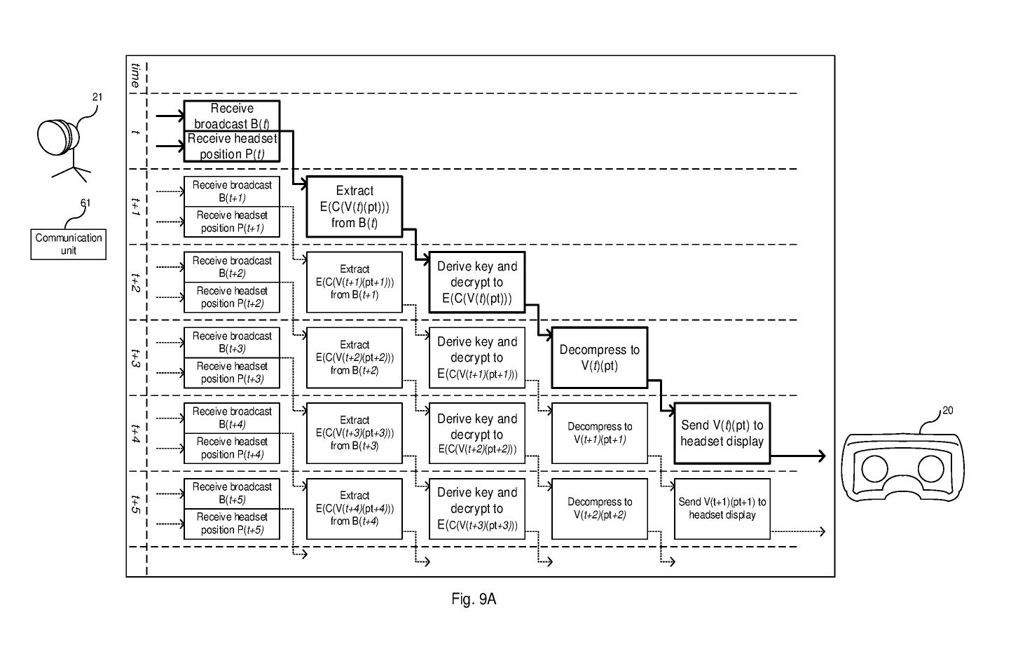

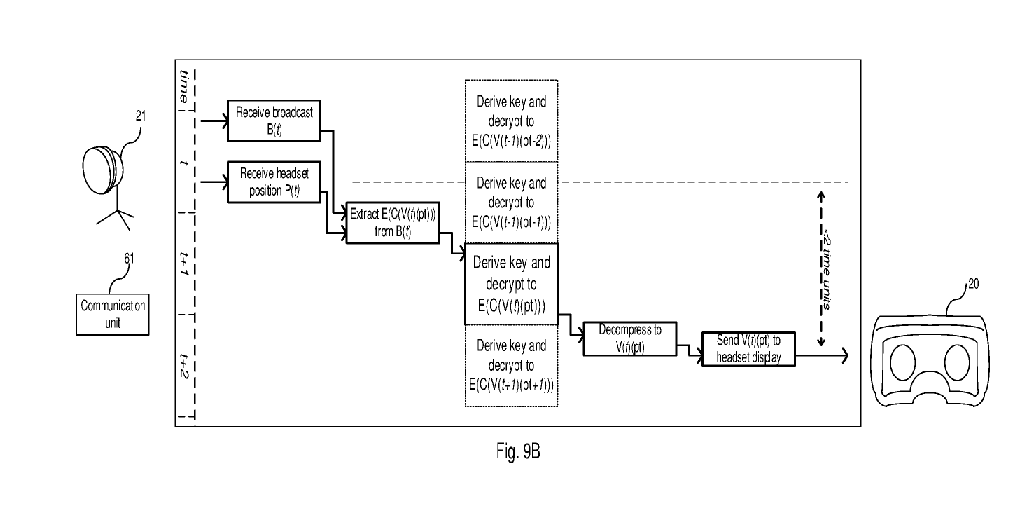

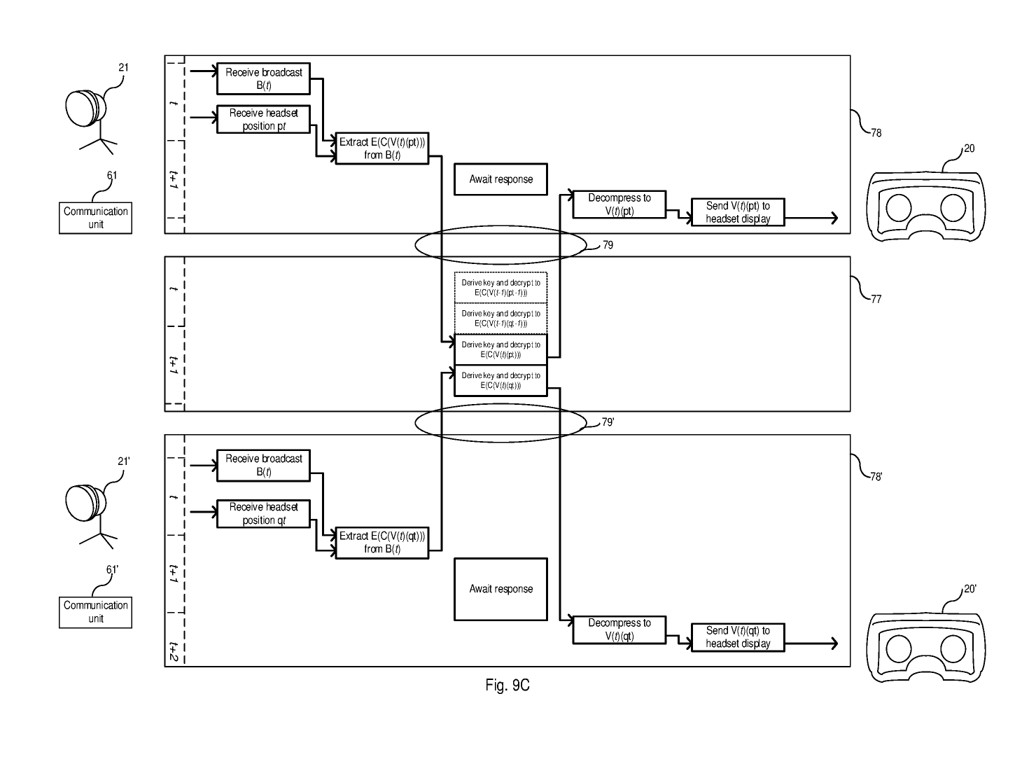

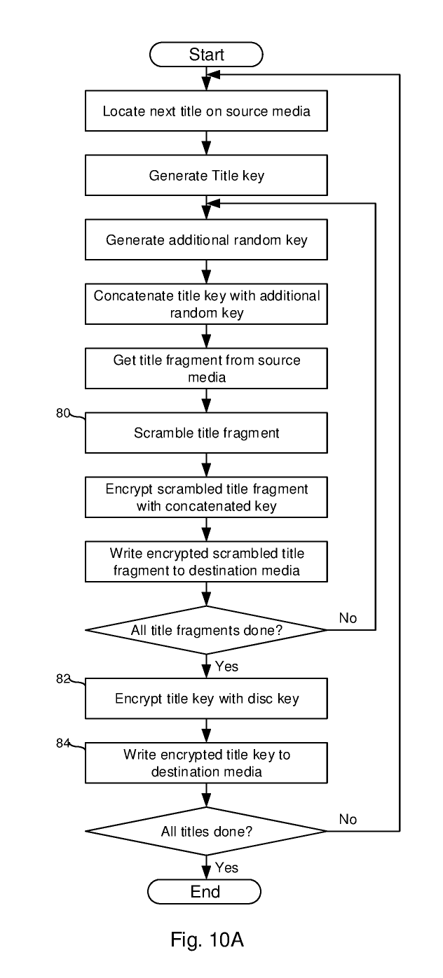

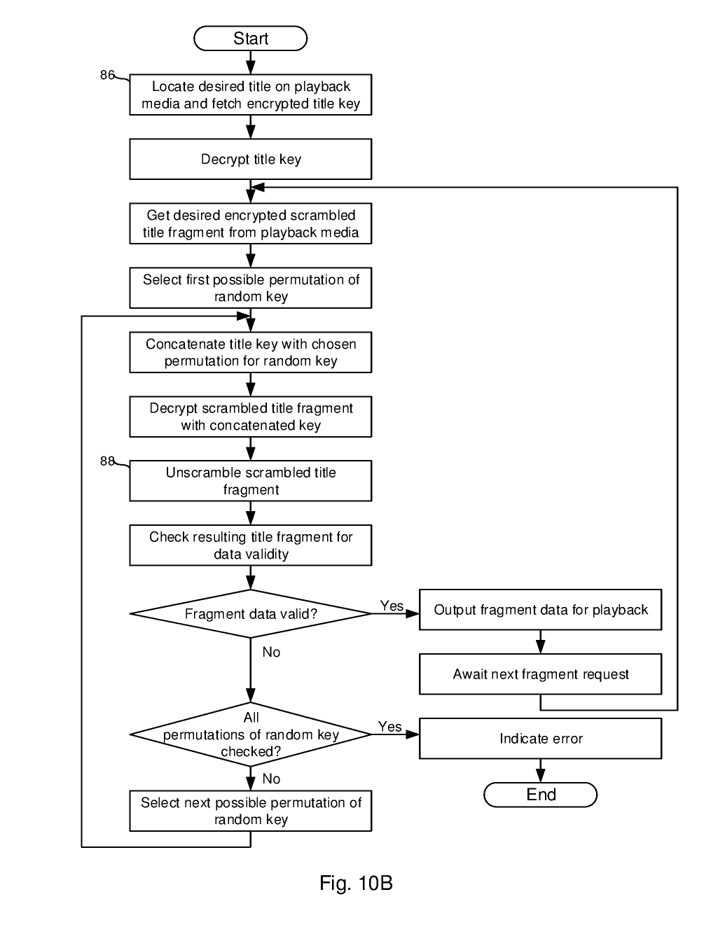

Reference is now made to FIG. 9A, which illustrates the pipelined process performed by decryption system 60. In FIG. 9A, there are multiple time lines, each for a time t+i, where i=0 . . . n, each of which has a number of operational steps happening thereon.

Decryption system 60 may receive, via communication unit 61, a broadcast stream B consisting of a stream of data B(t), where t may increment with every frame.

At time t, decryption system 60 may receive the portion B(t) of broadcast stream B pertaining to all the broadcast data for the time t and a value p(t) indicating the position of the user headset 20 for time t. The amount of data to be decrypted may be the amount of data that, after reconstruction, delivers a complete and correct picture to the user's eye for position p(t). The picture is to be displayed for a frame interval (which may be a period of 8.33 ms until the next frame becomes available). For simplicity, each block in FIG. 9A is of the same length, equivalent to the frame interval, although it will be clear that in many systems, some blocks will complete their tasks more rapidly than others. For simplicity, although generally two video frames are required to be extracted, one for each user eye in the headset, only one is shown in the pipeline drawing.

During the next period, starting at time t+1, decryption system 60 may continue by extracting E(C(V(t,p(t)))) from the broadcast stream B(t). At the same time, decryption system 60 may receive B(t+1), the next portion of the broadcast stream.

During the next period, starting at time t+2, decryption system 60 may derive the key with which to decrypt E(C(V(t)(p(t)))), extract E(C(V(t+1,p(t+1)))) from the broadcast stream B(t+1) and receive B(t+2), the next portion of broadcast stream. As discussed hereinabove, the key derivation process is a limited exhaustive key search, performed by systematic value generator 68, key mixer 66, decrypter 64 and valid fragment detector 70 and the process may take a varied length of time which may be bounded such that it may always complete within one frame interval.

During the next period, starting at time t+3, decryption system 60 may decompress compressed piece of video C(V(t,p(t))) to give the video V(t,p(t)) relating to time t and to viewing position p(t) and, at time t+4, the video V(t,p(t)) is then delivered to headset 20. Additionally, at time t+3, decryption system 60 may derive the key with which to decrypt E(C(V(t+1,p(t+1)))), may extract E(C(V(t+2,p(t+2)))) from the broadcast stream B(t+2) and may receive B(t+3), the next portion of broadcast stream.

As may be clearly seen from FIG. 9A, the key derivation and decryption of one fragment of data may be performed at the same time as the decoded, decrypted image data for a previous fragment of data is sent to the headset.

Reference is now briefly made to FIG. 9B, which illustrates a pipeline where certain stages take less time than the frame interval, allowing the overall pipeline latency to be about 2 time units, which is less than that of FIG. 9A. Nevertheless, it will be clear that the throughput of such a pipeline may be limited by the rate at which any stage, and particularly the key derivation stage, occurs.

Reference is now briefly made to FIG. 9C, which illustrates multiple pipelines needed to serve two headsets 20 and 20′, where the second headset 20′ may be tracked by a second tracking system 21′ (providing positions q(t)) and may receive identical data using communication unit 61′. Three pipelines are shown, pipelines 78 and 78′ showing the actions of the decryption systems 60 for headset 21 and 21′, respectively, and pipeline 77 for a central key deriver (formed of systematic value generator 68, key mixer 66, decrypter 64 and valid fragment detector 70) serving both decryption systems.

FIG. 9C shows “data links” 79 and 79′ that allow pipelines 78 and 78′ to request that the central key deriver decrypt their chosen fragments. Clearly the central key deriver can only serve both users if the hardware complexity bottleneck is chosen to be half that which would be required to serve a single user.

Reference is now briefly made to FIGS. 10A and 10B, which illustrate an alternative process to be performed by encryption system 30 and decryption system 60, respectively. In the alternative embodiment of FIGS. 10A and 10B, a scrambling stage is included. In this embodiment, in the encryption process of FIG. 10A, a scrambling step 80 is included and the disclosed key (here listed as the “title key”) is encrypted (step 82). FIG. 10B also includes that the encrypted data is written (step 84) to a destination media, rather than being transmitted or broadcast, although this may be implemented independently of scrambling step 80.

For the alternative process of decryption system 60 whose method is shown in FIG. 10B, the new steps are: the encrypted title key DK is fetched (step 86) in encrypted form from the playback medium and decrypted, according to prior art techniques, to give the title key DK and the candidate decrypted fragment is unscrambled (step 88) prior to its validity being checked. The remaining steps of FIGS. 10A and 10B are believed to be understandable from the explanation provided hereinabove.

It will be appreciated that the scrambling may be any suitable scrambling process which may be an easily, reversible, non-secret process. The scrambling may be any process of modifying the data of the fragment prior to encryption, such as substitution, position changes, XORing, or other techniques that may be used to perform a reversible mixing of the data, such that the no significant part of the mixed data may be deduced without all of the data present. In this way, the scrambling technique may reduce attacks whereby only part of the fragment might be decrypted in order to determine whether the decryption key was correct.

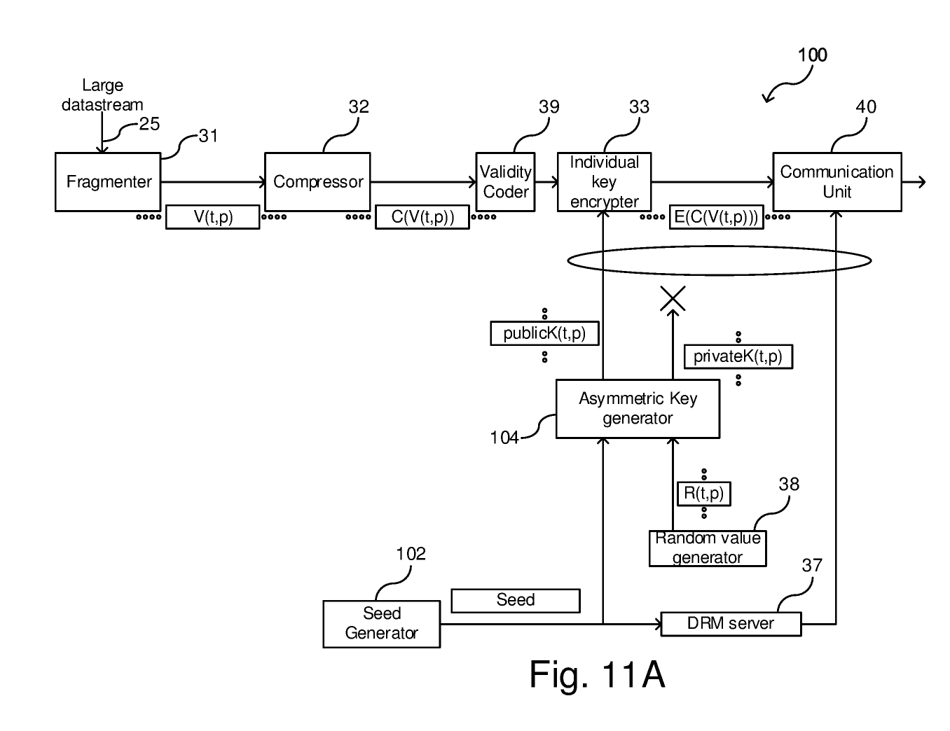

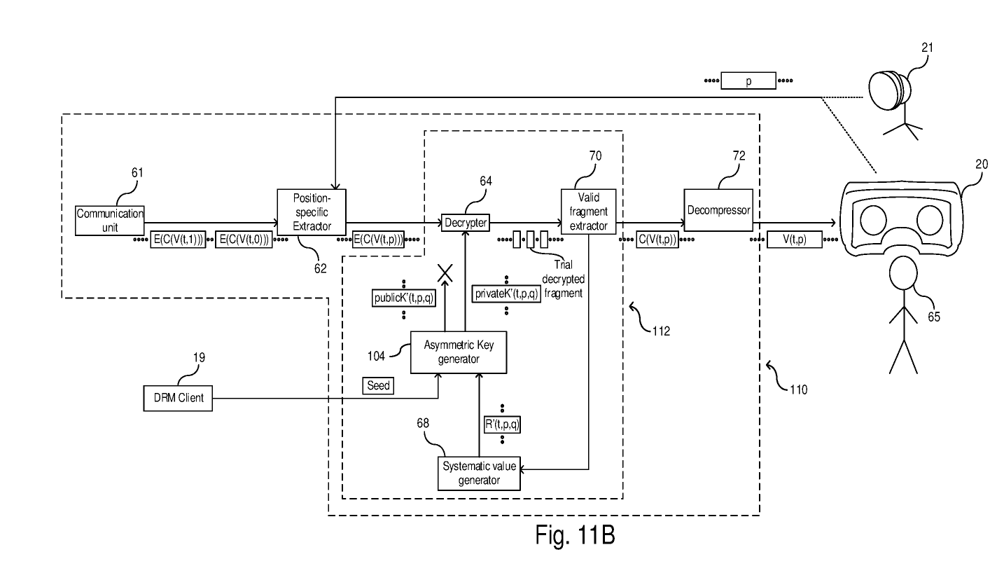

It will be noted that the techniques described hereinabove may also be applied to encryption schemes employing asymmetrical keys, such as public-private key encrypting. This is shown in FIGS. 11A and 11B, to which reference is now briefly made. FIG. 11A illustrates an encryption system 100, based on encryption system 30, which may provide the public key encryption and FIG. 11B illustrates a decryption system 110, based on decryption system 60 which may provide the private key decryption. Similar elements have similar reference numerals.

In encryption system 100, title key generator 34 may be replaced with a seed generator 102 which may produce a “seed” that may be maintained for all fragments and key mixer 36 may be replaced with an asymmetric key generator 104 which may combine the seed with each random parameter R(t,p), generated by random value generator 38 and may generate, from the combined values, a set of public-private key pairs. Asymmetric key generator 104 may discard the private keys but may provide the public keys, labeled public K(t,p), to individual key encrypter 33 for encryption.

In some alternative embodiments, the content owner may provide the public keys to a third party (for example, a content provider) to encrypt the fragments using the provided public keys.

As shown in FIG. 11B, decryption system 110 may comprise an asymmetric key deriver 112 which may replace key mixer 66 with an asymmetric key generator 104. In this embodiment, asymmetric key generator 104 may mix the received seed, shown in FIG. 11B as being provided by DRM client 19, with the trial values R′(t,p,q) generated by systematic value generator 68 and may generate a set of public-private key pairs therefrom. As opposed to encryption system 100, decryption system 110 may provide only the private keys private K(t,p) of the pairs to decrypter 64. Asymmetric key deriver 112 may perform the limited exhaustive key search described hereinabove to find the random parameter needed to generate the associated individual private key needed to decrypt that fragment.

Thus, public keys may be used to encrypt fragments and private keys may be used to decrypt fragments. With this approach, a central body may provide one entity with many public keys with which to encrypt a large datastream, such as a VR broadcast produced by the entity rather than the central body, and other entities, such as the viewers, may be provided with a single disclosed seed DK from which the private keys may be derived for decrypting individual fragments . Under such a scheme, due to the destruction of the random parameters and private keys, not even the central body can realistically decrypt the entire datastream. Everyone, including the central body and the one performing the encryption, is only capable of decrypting a small portion of the entire data stream in real time.

It will also be noted that the system may be used for foveated imaging or rendering, where the datastream contains the high-resolution content for the angle at which the user is directly looking at. Other areas of the screen may be provided with lower-resolution images.

Alternatively, or in addition, individual keys may be re-utilized for multiple fragments, particularly if there are groups of fragments that will not be used when one fragment is selected. For example, a fragment which represents a view of a scene at 180 degrees away from the current viewing direction may utilize the same encryption key.

It will also be noted that the content that may be encrypted need not be in compressed form. Such content may, in addition to providing potentially higher output quality, be more easily broken up into independent fragments such that the data of a decrypted fragment (e.g. of a particular viewing angle that has not yet been decrypted) may be difficult to construct from the decrypted data of fragments of nearby viewing angles.

While many of the descriptions above have related to user position (which may be a combination of user location and viewing angle), it will be appreciated that there are many other systems that select viewer-directed fragments of a large datastream. In some systems, the choice of fragment may be a function of the user's position, such as their position in the room, tilt of their head, etc. In other systems, the choice of fragment may include a choice of spectral content (for example, to reflect that different viewers have different sensitivities to differing wavelengths of visible light). In some systems, the choice of fragment may include other user choices, such as, for example, in an animated film, the shape of the main characters of the film. Likewise, in some systems where the source information may be computer-generated, the choice of fragment may also include aspects such as the costume worn by the characters of the film, weapons used by characters, locations used, alternate presentation of protagonists, and so forth.

Likewise, it will be appreciated that other elements of the content may also be affected by user selections. For example, the audio content fed to the user may well be such that it is a function of head angle and other such choices.

It should also be noted that, while much of the description has been of a system to encode video content, the techniques described may also be applied to many other fields where only a subset of data is to be consumed. Consider, for example, a digital library that may be created of children's toy construction pieces that may be 3D printed at home. The library may be licensed to a user such that they may select from many thousands of pieces to print, that they may print as many copies of an individual piece that they desire, but that they may only select a single piece to print per hour. In a case like this, the data for each piece may be considered to be a fragment, with the techniques described previously (such as concatenation of a random parameter into the encryption key) used to prevent a user unlocking fragment data at a rate substantially higher than one piece per hour.

Another alternative embodiment may be an online, highly detailed road map, including up-to-date information, such as road surface defects. The map data may be arranged as a series of fragments such that each fragment may contain data related to a small patch of road surface, and may be arranged such that a consumer of the map data (such as a smart car) may be capable of decrypting data pertaining to the particular part of road that the tires are about to be on, but where it would take considerably greater effort to decrypt all the data relating to a larger road surface.

It will be appreciated that the present invention may be utilized for any type of data where an individual user is expected or allowed to consume a small subset in real-time, like a highly-localized weather forecast, a highly-accurate map, a database of stock prices, etc., and where licensing access to a real-time, user-selectable portion of the data is desired but access to a greater portion of the dataset is to be prevented.

Unless specifically stated otherwise, as apparent from the preceding discussions, it is appreciated that, throughout the specification, discussions utilizing terms such as “processing,” “computing,” “calculating,” “determining,” “encrypting,” “decrypting,” “compressing,” “decompressing,” “extracting,” “generating,” “sending,” “receiving,” “transmitting,” “mixing,” “providing,” “producing,” “deriving,” or the like, may also refer to the action and/or processes of a general purpose computer of any type such as a client/server system, a mobile computing devices, a set-top box, a game console, a media playback device, a tablet, a smart appliance or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose processor-based system, a programmable parallel computing platform, a programmable digital signal processing device or a configurable logic device, such as FPGA, selectively activated or reconfigured by a software program or a configuration, in the case of the FPGA, stored in the system. The resultant apparatus when instructed by software may turn the general purpose computer into inventive elements as discussed herein. The instructions may define the inventive device in operation with the computer platform for which it is desired. Such a configuration may be formed by computer program, by logic programming configuration and so forth, and may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus.

The processes and operations presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description above. In addition, embodiments of the present invention are not described with reference to any particular programming language. It will be appreciated that a variety of hardware and software programming techniques and languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A content protection system comprising:
an encrypter to encrypt fragments of a datastream, each with one of a multiplicity of related encryption keys, so as to require a decrypter to use limited exhaustive key searches to determine corresponding decryption keys.

2. The system of claim 1 wherein said encrypter comprises:
a key generator to generate said encryption keys, wherein each encryption key is a function of a disclosed key and an additional random parameter; and
an individual key encrypter to encrypt each said fragment with its associated encryption key.

3. The system of claim 2 wherein said encrypter comprises a distributor to encrypt said disclosed key via a DRM (digital rights management) server and to distribute said encrypted fragments and said encrypted disclosed key to recipients.

4. The system of claim 2 and wherein at least one of an entropy and a size of said random parameter limits a rate at which said decrypter derives correct encryption keys.

5. The system of claim 2 and wherein said key generator comprises:
a random value generator to generate a multiplicity of additional random parameters; and
a key mixer to mix said disclosed key with each said additional random parameter.

6. The system of claim 2 and also comprising a validity coder to add an associated validation code to each of said fragments.

7. The system of claim 1 and also comprising a scrambler, operative on said fragments prior to encryption by said individual key encrypter.

8. The system of claim 1 and wherein only a user-selectable portion of said datastream is to be provided to said user and access to an entirety of said datastream is to be prevented.

9. The system of claim 8 and wherein said content is one of: virtual reality content, foveated content, a digital library, an online, map, a localized weather forecast, and a database of stock prices.

10. The system of claim 1 and wherein said fragment is a small packet associated with a larger portion of said datastream.

11. The system according to claim 3 wherein said disclosed key is a seed used in forming pairs of public and private keys, wherein said distributor distributes an encrypted version of said seed and each encryption key is a public key generated from said seed key and said additional random parameter.

12. A content presentation system comprising:
a fragment selector to select a fragment of a datastream to present to a user based on a user selection; and
a key deriver to derive an individual decryption key for said selected fragment, said individual key formed from a received disclosed key for said datastream and an additional random parameter, said key deriver to find the value of said additional random parameter and to use said individual key to decrypt said selected fragment.

13. The system according to claim 12 wherein said user-selection is one of: an area which the user is looking directly at, user location and viewing angle, the tilt of the user's head, spectral content or shape, costume, weapon or location of main characters of a film, a single item of a library, the user's location, and the user's currently selected stock.

14. The system of claim 12 and wherein said key deriver comprises a limited exhaustive key searcher to search for permutations of said additional random parameter.

15. The system of claim 12 and wherein said key deriver comprises:
a systematic value generator to generate a random parameter;
a key mixer to mix said disclosed key with said random parameter to generate a candidate key;
a decrypter to attempt to decrypt an incoming fragment with said candidate key; and
a valid fragment detector to determine if the output of said decrypter is valid and to instruct said systematic value generator to generate another random parameter if not.

16. The system of claim 15 and also comprising a descrambler to descramble said fragments.

17. The system of claim 15 and wherein said valid fragment detector comprises at least one of: a data format checker to check that said fragment contains valid data patterns according to a known fragment format, a data value checker to check that said fragment data values are valid according to a known fragment data scheme, a CRC checker to check the cyclic redundancy check (CRC) of said fragment and a header checker to check header information for expected values of header information.

18. The system of claim 12 and wherein said datastream comprises content of one of: a virtual reality content, foveated content a digital library, an online map, a localized weather forecast, and a database of stock prices.

19. The system of claim 12 and wherein said fragment is a small packet associated with a larger portion of said datastream.

20. The system of claim 12 and wherein a rate at which said key deriver generates said valid fragment defines the size of said random parameter.

21. The system of claim 12 and wherein said rate is one of: less than a time interval for displaying said fragment or an image associated with said fragment, to said user, and less than half a time interval for displaying said fragment or an image associated with said fragment, to said user allowing time for two fragments to be decoded for provision to both user eyes, less than quarter a time interval for displaying two said fragments or images associated with said fragments, to said user, leaving time for said key deriver to derive two additional valid fragments for a second user.

22. The system of claim 12 and also comprising a DRM client to decrypt said disclosed key from a transmitted encrypted version.

23. The system according to claim 22 wherein said disclosed key is a seed used in forming pairs of public and private keys, wherein said DRM client decrypts an encrypted version of said seed and wherein said key deriver generates said private key from said seed and said additional random parameter.

24. A content protection method comprising:
encrypting fragments of a datastream, each with one of a multiplicity of related encryption keys, so as to require limited exhaustive key searching to determine corresponding decryption keys.

25. The method of claim 24 wherein said encrypting comprises:
generating said encryption keys, wherein each encryption key is a function of a disclosed key and an additional random parameter; and
encrypting each said fragment with its associated encryption key.

26. The method of claim 25 and also comprising encrypting said disclosed key via a DRM server and distributing said encrypted fragments and said encrypted disclosed key to recipients.

27. The method of claim 25 and wherein at least one of an entropy and a size of said random parameter limits a rate at which said searching derives correct encryption keys.

28. The method of claim 25 and wherein said generating comprises:
generating a multiplicity of additional random parameters; and
mixing said disclosed key with each said additional random parameter.

29. The method of claim 25 and also comprising adding an associated validation code to each of said fragments.

30. The method of claim 24 and also comprising scrambling said fragments prior to said encrypting.

31. A content presentation method comprising:
selecting a fragment of a datastream to present to a user based on a user selection;
deriving an individual decryption key for said selected fragment, said individual key formed from a received disclosed key for said datastream and an additional random parameter, said deriving including finding the value of said additional random parameter; and
using said individual key to decrypt said selected fragment.

32. The method according to claim 31 wherein said user-selection is one of: an area which the user is looking directly at, user location and viewing angle, the tilt of the user's head, spectral content or shape, costume, weapon or location of main characters of a film, a single item of a library, the user's location, and the user's currently selected stock.

33. The method of claim 31 and wherein said deriving comprises performing limited exhaustive searches for permutations of said additional random parameter.

34. The method of claim 31 and wherein said deriving comprises:
systematically generating a random parameter;
mixing said disclosed key with said random parameter to generate a candidate key;
attempting to decrypt an incoming fragment with said candidate key; and
determining if the output of said attempting is valid and repeating said systematically generating, mixing and attempting if not.

35. The method of claim 34 and also comprising descrambling said fragments.

36. The method of claim 31 and wherein said determining comprises at least one of: a checking that said fragment contains valid data patterns according to a known fragment format, checking that said fragment data values are valid according to a known fragment data scheme, checking the cyclic redundancy check (CRC) of said fragment and checking header information for expected values of header information.

37. The method of claim 31 and wherein a rate at which said deriving generates said valid fragment defines the size of said random parameter.

38. The method of claim 31 and also comprising decrypting said disclosed key from a transmitted encrypted version.
